(19) United States
(12) Patent Application Publication
(10) Pub. No.: US 2026/0044336 A1
(43) Pub. Date: Feb. 12, 2026

(54) GATEWAY AND GATEWAY HOT UPGRADE METHOD AND SYSTEM

(71) Applicant: CLOUD INTELLIGENCE ASSETS HOLDING (SINGAPORE) PRIVATE LIMITED, Singapore (SG)

(72) Inventors: Zhongjie WANG, Beijing (CN); Wenhao SHI, Beijing (CN); Binbin WANG, Hangzhou, Zhejiang (CN); Tao WANG, Beijing (CN)

(21) Appl. No.: 19/150,077

(22) PCT Filed: Apr. 11, 2024
(86) PCT No.: PCT/CN2024/087329

§ 371 Date: Jul. 22, 2025

(30) Foreign Application Priority Data
Apr. 17, 2023 (CN) 202310436793.0

(51) Int. Cl. G06F 8/656

(52) U.S. Cl. CPC G06F 8/656

(57) ABSTRACT

The present disclosure discloses a gateway and a gateway hot upgrade method and system, related to the field of cloud computing. The method includes that: a connection between a parent process before a hot upgrade of a service request and a child process after the hot upgrade of the service request is cut off in response to receiving an exit signal, where the service request is used for establishing the connection between the child process after the hot upgrade and the parent process before the hot upgrade, and the child process is used for receiving port information and file descriptor information transferred by the parent process after the connection is established; and the parent process is exited, and the service request is processed based on the port information and the file descriptor information through the child process.

The present disclosure claims priority of Chinese Patent Application No. 202310436793.0, filed to China National Intellectual Property Administration on Apr. 17, 2023 and titled “GATEWAY AND GATEWAY HOT UPGRADE METHOD AND SYSTEM”, the content of which is hereby incorporated by reference in its entirety.

### TECHNICAL FIELD

The present disclosure relates to the field of cloud computing, and in particular, to a gateway and a gateway hot upgrade method and system.

### BACKGROUND OF THE INVENTION

This part is intended to provide a background or a context for embodiments of the present disclosure stated in the claims. The description herein is not admitted to be the related art although included in this part.

As a key facility carrying inbound and outbound traffic on a machine, a gateway needs to have a hot upgrade function during redeployment or upgrade of an application, so that inbound and outbound traffic on the gateway is not obstructed, thereby not interrupting service requests and responses on the machine, and ensuring service availability of the machine. In an existing gateway hot upgrade solution, a child process receives a file descriptor (FD) transmitted by a parent process, and then sends a message to the parent process, so that the parent process performs exiting. However, the parent process mechanically waits for a time period to exit, and an exit may occur for a request without receiving a reply within the waiting time period, which cannot ensure a graceful exit of a process.

### SUMMARY OF THE INVENTION

Embodiments of the present disclosure provide a gateway and a gateway hot upgrade method and system, which can at least optimize an exit process of a parent process and enable the parent process to exit gracefully.

According to an aspect of the present disclosure, a gateway hot upgrade method is further provided, including that: a connection between a parent process before a hot upgrade of a service request and a child process after the hot upgrade of the service request is cut off in response to receiving an exit signal, where the service request is used for establishing a connection between the child process after the hot upgrade and the parent process before the hot upgrade, and the child process is used for receiving port information and file descriptor information transferred by the parent process after the connection is established; and the parent process is exited, and the service request is processed based on the port information and the file descriptor information through the child process.

According to another aspect of the present disclosure, a gateway hot upgrade system is further provided, including a control module and a processing module, where the control module is configured to cut off a connection between a parent process before a hot upgrade of a service request and a child process after the hot upgrade of the service request in response to receiving an exit signal, where the service request is used for establishing a connection between the child process after the hot upgrade and the parent process before the hot upgrade, and the child process is used for receiving port information and file descriptor information transferred by the parent process after the connection is established; and the processing module is configured to exit the parent process, and process the service request based on the port information and the file descriptor information through the child process.

According to another aspect of the present disclosure, a gateway is further provided. The gateway performs a gateway hot upgrade according to the steps of the foregoing method.

According to another aspect of the present disclosure, an electronic device is further provided, including: a processor; and a memory storing a program, where the program includes instructions, and the instructions, when executed by the processor, causes the processor to perform the foregoing method.

According to another aspect of the present disclosure, a non-transitory computer-readable storage medium storing computer instructions is further provided, where the computer instructions are used for causing a computer to perform the steps of the foregoing method.

According to another aspect of the present disclosure, a computer program product is further provided. The computer program product includes a computer program, and the computer program, when executed by a processor, implements the steps of the foregoing method.

The embodiments of the present disclosure have the following beneficial effects.

In the embodiments of the present disclosure, the connection between the parent process before the hot upgrade of the service request and the child process after the hot upgrade of the service request is cut off in response to an exit signal being received, where the service request is used for establishing the connection between the child process after the hot upgrade and the parent process before the hot upgrade, and the child process is used for receiving port information and file descriptor information transferred by the parent process after the connection is established; and the parent process is exited, and the service request is processed based on the port information and the file descriptor information through the child process. In the present disclosure, the connection between the parent process before the hot upgrade of the service request and the child process after the hot upgrade is cut off when the exit signal is received, and an operation of disconnecting the connection between the parent process and the child process is performed based on the exit signal, to implement control over an exit process of the parent process, thereby reducing a situation where the service request does not receive a reply within a waiting time period and the parent process exits, and further ensuring a graceful exit of the parent process.

Details of at least one embodiment of the present disclosure are provided in the following accompanying drawings and descriptions to make other features, objectives, and advantages of the present disclosure clearer and easier to understand.

### BRIEF DESCRIPTION OF DRAWINGS

In the accompanying drawings, unless otherwise specified, the same reference numerals throughout multiple figures represent the same or similar components or elements. The accompanying drawings are not necessarily drawn to scale. It should be understood that the accompanying drawings illustrate some implementations disclosed in the present disclosure, and should not be construed as a limitation on the scope of the present disclosure.

FIG. 1 is a flowchart of a gateway hot upgrade method according to some embodiments of the present disclosure.

FIG. 2 is a schematic diagram of an existing gateway hot upgrade method according to some embodiments of the present disclosure.

FIG. 3 is a schematic diagram of a gateway hot upgrade method according to some embodiments of the present disclosure.

FIG. 4 is a structural block diagram of an exemplary electronic device configured to implement some embodiments of the present disclosure.

### DETAILED DESCRIPTION OF THE INVENTION

Embodiments of the present disclosure are to be described in more detail below with reference to the accompanying drawings. Although some embodiments of the present disclosure are shown in the accompanying drawings, it should be understood that the present disclosure may be implemented in various forms, and should not be construed as being limited to the embodiments described herein. On the contrary, these embodiments are provided to provide a more thorough and complete understanding of the present disclosure. It should be understood that the accompanying drawings and the embodiments of the present disclosure are for illustrative purposes, and are not intended to limit the protection scope of the present disclosure.

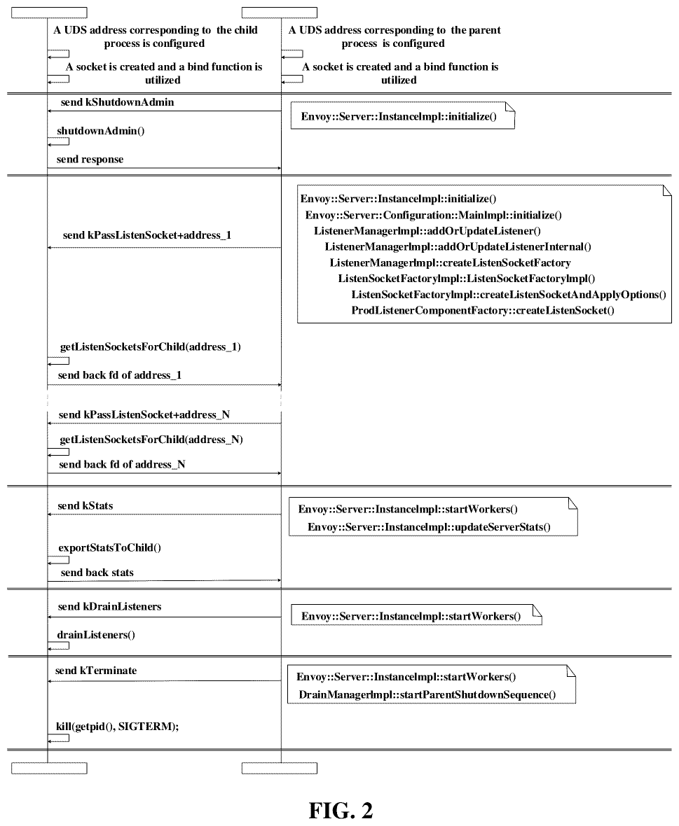

Currently, in an existing gateway hot upgrade solution, referring to a schematic diagram of an existing gateway hot upgrade method shown in FIG. 2, when a parent process and a child process are started, a socket is created and bound to a specific Unix Domain socket (UDS) file through a bind function (a function for binding a Socket to a local address (an IP address and a port number)): for an application deployed for the first time, since the application has no parent process, the UDS file may be created. However, for a child process during a subsequent hot upgrade, since the child process has a parent process, the child process may communicate with the parent process by directly opening a UDS file of the parent process thereof. In the solution, the following steps are all described based on a case in which the child process has a parent process during the hot upgrade.

In step 1, before bind processing, a child process needs to first send a message of shutDownParent (an instruction for shutting down a parent process) to a parent process, and after receiving the message, the parent process starts to stop listening (listener) and shuts down a socket. In this way, a new connection may fail fast (fail-fast), and the new connection is prevented from entering an accept queue.

In step 2, after receiving a response in step 1, the child process sends a passListenSocket (an instruction for transferring a listened Socket) message, where the message carries a FD type to be transmitted. For example, when the gateway currently opens an inbound port and an outbound port, the inbound, the outbound, and the FD bound to the parent process are transmitted to the child process, and when there is a new open port in the future, the transmission is continued.

In step 3, when encryption of Transport Layer Security (TLS) is enabled, the gateway is in a certain state.

In step 4, the child process receives a new connection after receiving the FD transmitted by the parent process, and the child process sends a drainListenerAndkillParent (an instruction for instructing the parent process to exit) message, to enable the parent process to exit gracefully. In this case, the remaining task of the parent process is to complete the processing of the established connection. A certain time is reserved herein for processing. Upon completion of processing, the FD is cleaned up to prevent leakage, and then a graceful exit is performed.

In the foregoing solution, the parent process mechanically waits for a time period to exit, and an exit may occur for a request without receiving a reply within the waiting time period, which cannot ensure a graceful exit of a process.

The gateway needs to have a high availability characteristic to serve as an infrastructure to ensure reliability of network communication of a component it is responsible for proxy.

Therefore, based on the foregoing background, the present disclosure provides a gateway and a gateway hot upgrade method and system. According to the method, a process of a parent process exiting is optimized, so that the parent process exits gracefully.

Terms involved are described below.

Hot upgrade refers to an act of performing an upgrade without interrupting an application service.

Gateway software is software for conversion and proxy of a network request, which may run on an ordinary computer or server to implement communication between different networks or protocols through the software. The gateway software usually includes a router, a firewall, a proxy server, and the like, and may implement different gateway functions.

Graceful exit refers to normal termination or shutdown of a program, a system, or a network connection. Such an exit manner may avoid an exception or an error occurring when the program or the system ends, and avoid data loss or damage, thereby ensuring data integrity and security.

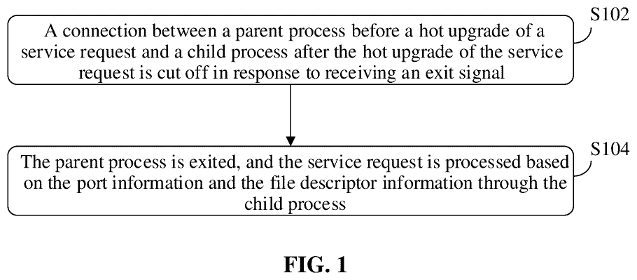

Some embodiments provide a gateway hot upgrade method. The method is applied to a server. The server provides a gateway service to a client based on a service request of the client. The gateway service is implemented through gateway software. FIG. 1 is a flowchart of a gateway hot upgrade method according to some embodiments of the present disclosure. Steps of the method involved in FIG. 1 are described below.

In step S102, a connection between a parent process before a hot upgrade of a service request and a child process after the hot upgrade of the service request is cut off in response to receiving an exit signal, where the service request is used for establishing a connection between the child process after the hot upgrade and the parent process before the hot upgrade, and the child process is used for receiving port information and file descriptor information transferred by the parent process after the connection is established.

In this step, the service request is sent by a client to a gateway, to request, through the gateway, a service from a server where the client is located. It should be noted that the gateway is a hardware device, or is implemented through gateway software. The service request is used for establishing the connection between the child process after the hot upgrade and the parent process before the hot upgrade, and the child process is used for receiving port information and file descriptor information transferred by the parent process after the connection is established.

The port information is used for determining a port transferred from the parent process to the child process. The port is configured to implement functions such as receiving a data packet, performing filtering and security check on the data packet, performing network address translation, and sending a data packet. A specific port is determined according to an actual requirement. This is not specifically limited in some embodiments of the present disclosure. In computer network programming, a Socket is a communication mechanism that allows different processes to communicate on a network. In the Socket, an operation is usually performed through an FD. An FD is an integer that is a unique identifier assigned by an operating system kernel to each opened file or device. In Socket programming, a Socket FD refers to a FD of a Socket connection, which is an integer used for identifying a Socket connection. A Socket FD may be configured to send and receive data, and perform another Socket operation, such as setting a Socket option and closing a Socket connection. In Socket programming, the Socket FD is usually created through a Socket function.

In this step, a process is an instance of a running program. A process is a basic execution unit in a computer system, which includes information such as program code, data, and an execution state. The process usually performs communication through a Socket mechanism, and each process may create at least one Socket connection for communication with another process. The communication between processes is synchronous or asynchronous, and data is sent and received through a Socket, or is exchanged through another communication mechanism. In this step, a hierarchical relationship exists between the parent process and the child process. The child process is a copy of the parent process. The child process and the parent process share some resources, for example, share port information and file descriptor information, but some resources are further independent. An existing process before the gateway hot upgrade is used as the parent process, and a process used after the gateway hot upgrade that shares information such as port information and file descriptor information with the parent process is used as the child process.

In this step, the exit signal is used for determining a time point for starting execution of an asynchronous processing task. The exit signal is sent in a form of a message, an instruction, or the like. The message is information transferred in a communication process, which is for example in a form of a text, a picture, audio, or a video. The instruction is used for controlling, adjusting, and configuring parameters of a device or a system, to achieve a specific purpose. A form used by the exit signal is determined based on an actual requirement by a terminal from which the exit signal is sent. This is not specifically limited in this embodiment of the present disclosure.

In this step, when an exit signal is received, an operation of cutting off the connection between the parent process and the child process is started through the exit signal, to achieve control over the disconnection operation, thereby reducing a situation where a request does not receive a reply within a waiting time period and the parent process exits.

In step S104, the parent process is exited, and the service request is processed based on the port information and the file descriptor information through the child process.

In this step, exiting the parent process indicates to end the currently running parent process and release system resources occupied by the parent process. The service request is processed based on the port information and the file descriptor information through the child process, where the child process is configured to perform some or all of tasks of the exited parent process.

It should be noted herein that all or some of tasks processed by the parent process are transferred to the child process for processing through the gateway hot upgrade.

In addition, it should be noted that when a certain child process has no corresponding parent process, it indicates that this process is deployed for the first time, and a UDS file of the process is created, and port information and file descriptor information of the process are obtained through the newly created UDS file.

In the embodiments of the present disclosure, the connection between the parent process before a hot upgrade of the service request and the child process after the hot upgrade of the service request is cut off when the exit signal is received, where the service request is used for establishing the connection between the child process after the hot upgrade and the parent process before the hot upgrade, and the child process is used for receiving port information and file descriptor information transferred by the parent process after the connection is established; and the parent process is exited, and the service request is processed based on the port information and the file descriptor information through the child process. In the present disclosure, the connection between the parent process before the hot upgrade of the service request and the child process after the hot upgrade is cut off when the exit signal is received, and an operation of disconnecting the connection between the parent process and the child process is performed based on the exit signal, to implement control over an exit process of the parent process, thereby reducing a situation where the service request does not receive a reply within a waiting time period and the parent process exits, and further ensuring a graceful exit of the parent process.

In some embodiments, the gateway hot upgrade method further includes the following step. An asynchronous processing task of the service request is generated, where the asynchronous processing task is used for cutting off the connection between the parent process and the child process. And an operation of cutting off the connection between the parent process before the hot upgrade of the service request and the child process after the hot upgrade of the service request in response to receiving the exit signal includes the following step. The asynchronous processing task is performed through an asynchronous processing component.

In some embodiments, after receiving the service request, the gateway generates one asynchronous processing task corresponding to each service request. For example, the asynchronous processing task may be a Tokio (one asynchronous input/output (I/O) runtime library, which provides an efficient manner to write asynchronous, concurrent, and extensible network applications) task, and the asynchronous processing task is used for cutting off the connection between the parent process and the child process.

It should be noted that the asynchronous processing task may refer to a coroutine, and may be paused and resumed during execution, thereby implementing switching and scheduling of a task.

In this step, one asynchronous processing task corresponding to each service request is generated, and after the task is performed, the connection between the parent process and the child process is cut off, so that a connection state between the parent process and the child process is controlled through control over the execution of the asynchronous processing task, that is, timing for releasing the connection may be controlled.

An asynchronous processing component is configured to perform the asynchronous processing task, to cut off the connection between the parent process and the child process. The asynchronous processing component is implemented based on a select macro. The select is a system call used for waiting for data to arrive on multiple file descriptors. The select macro is a function that encapsulates the select system call and is used for waiting for data to arrive on a set of file descriptors.

In this step, the asynchronous processing task is performed through the asynchronous processing component only when the exit signal is received, so that an operation of cutting off the connection between the parent process and the child process is started through the exit signal, to achieve control over the disconnection operation, thereby reducing a situation where a request does not receive a reply within a waiting time period and the parent process exits.

In some embodiments, the exit signal is sent by a client or a server. The asynchronous processing component includes a first processing component and a second processing component, and an operation of performing the asynchronous processing task through the asynchronous processing component includes the following steps. The connection between the parent process and the child process is cut off through the first processing component in response to a first exit signal sent by the client being first received. The connection between the parent process and the child process is cut off through the second processing component in response to a second exit signal sent by the server being first received.

In some embodiments, the client and the server processes running on different computers, which perform communication through a network. The client sends a request message to the server, and the server receives and processes the request message, and finally returns a response message to the client.

When the gateway hot upgrade is performed, the client or the server may control exit of the parent process in the hot upgrade process. For example, when the client needs to suspend the hot upgrade and control the parent process to exit in advance, an exit signal is sent, and the exit signal sent by the client is used as a first exit signal. During a normal hot upgrade, the server may send an exit signal to control an exit timing of the parent process, and the exit signal sent by the server is used as a second exit signal. For example, in some embodiments, the second exit signal is sent after the child process completes processing the connection request or after a response to the connection request times out, thereby ensuring a graceful exit of the parent process.

When the first exit signal sent by the client is first received before the second exit signal sent by the server is received, an asynchronous processing task is performed through a first processing component to cut off the connection between the parent process and the child process. When the second exit signal sent by the server is first received before the first exit signal sent by the client is received, the asynchronous processing task is performed through a second processing component to cut off the connection between the parent process and the child process.

In this step, whichever of the first processing component and the second processing component is responded to first, the responded component is to process the corresponding task based on the received exit signal, thereby controlling the timing of disconnecting the parent process from the child process, and further ensuring the graceful exit of the parent process.

It should be noted that the first processing component or the second processing component is an independent module or component in a software system, and is developed, tested, deployed, and maintained separately, which may have a clearly defined interface and function, and is called and used by another component or system.

Considering that in a process management module, when a parent process is exited, a situation such as an abnormal exit is identified, and therefore the exited parent process is easily restarted, resulting in a waste of resources. In some embodiments, an operation of exiting the parent process includes the following steps. The parent process is identified based on a first identifier, and the child process is identified based on a second identifier, where the parent process is marked through the first identifier in advance in a process management module, and the child process is marked through the second identifier in advance in the process management module. The parent process is controlled to be in an exit state, and the child process is controlled to be in a running state.

In some embodiments, the process management module is configured to manage a process involved in the gateway. A specific process management manner adopted by the process management module is selected based on an actual requirement. This is not specifically limited in some embodiments of the present disclosure.

The first identifier and the second identifier are selected based on an actual requirement, for example, may include a special character, a number, and a character string. The parent process is marked through the first identifier in advance, and the child process is marked through the second identifier, so that the parent process and the child process are distinguished. Then the parent process is identified based on the first identifier, the child process is identified based on the second identifier, the parent process is controlled to be in an exit state, and the child process is controlled to be in a running state.

For example, in some embodiments, the process management module is implemented through Systemd (a process management manner based on a dependency relationship). The Systemd may automatically start and stop a system service, and may establish a dependency relationship between services, to ensure that the services are started and stopped in a correct order. When a gateway process is managed through the Systemd, and the Systemd has a function of adding a managed process to a daemon list (for example, some embodiments of the present disclosure are implemented by adding rustyncproxy.service to /usr/lib/systemd/system/), when the gateway process exits abnormally, Systemd can quickly start the gateway process in time to ensure high availability of the gateway process. However, this mechanism also brings considerable trouble to the hot upgrade of the present disclosure. Such a situation is considered below. A gateway parent process is guarded by Systemd. When a gateway child process connects to a UDS address of the parent process, the parent process gracefully exits after transferring FDs. In this case, the Systemd detects that the parent process has exited and restarts the parent process. Such a restart may affect the hot upgrade process.

To enable a parent process to exit and be never started up again, when the process management module is implemented through Systemd, a service template name of the process is configured as rustyncproxy@.service when a managed process is added to a daemon list of the Systemd. In other words, a character @ is added after the service name, and then the parent process is named as rustyncproxy@0.service, and the child process is named as rustyncproxy@1.service. In this way, during the hot upgrade, the parent process and the child process are distinguished through different parameters after @.

To ensure that Systemd can quickly start the gateway process when the gateway process experiences an unexpected crash, in some embodiments, after the parent process is exited, the following steps are further performed.

A return value after the parent process exits is received, where the return value includes a first return value or a second return value. The parent process is controlled to keep the exit state in response to the return value being the first return value. The parent process is started in response to the return value being the second return value.

In some embodiments, after the parent process is exited, a return value is sent. The return value includes a first return value and a second return value. The first return value is returned when the parent process exits normally. For example, the first return value is 0. The second return value is returned when the parent process exits abnormally. For example, the second return value is an exception prompt parameter, such as termination signal intelligence (SIGTERM).

In this step, return values are differentiated to obtain a first return value and a second return value, so that when a parent process exits normally, the parent process is controlled to keep the exit state, and the parent process is not repeatedly restarted during a hot upgrade. When the parent process exits abnormally, the parent process is started based on the second return value to alleviate a problem of the parent process exiting due to an unexpected circumstance.

The port information includes multiple types of port information. In some embodiments, the port information includes outbound port information and inbound port information. An operation of processing the service request based on the port information and the file descriptor information through the child process includes the following steps.

An outbound port is generated, through the child process, based on the outbound port information, and an inbound port is generated, through the child process, based on the inbound port information. A Socket file is generated based on the file descriptor information through the child process. The service request is processed through the Socket file, the outbound port, and the inbound port.

In some embodiments, the inbound port refers to a port through which a gateway device is used for receiving a data packet from an external network. The outbound port refers to a port through which the gateway device is configured to send a data packet to the external network. The foregoing two ports may also be configured to perform operations such as forwarding, routing, filtering, security check, and address translation, which are important components of the gateway device, and play an important role in protecting security of an internal network and implementing network communication.

After the parent process transfers the outbound port information, the inbound port information, and the file descriptor information to the child process, the child process may generate an outbound port, an inbound port, and a Socket file thereof based on received information, thereby implementing some or all of the functions that the parent process can implement.

In this step, the port information may include multiple types of port information, and is specifically set based on an actual requirement. This is not specifically limited in some embodiments of the present disclosure.

After the parent process is exited, the child process may serve as a new parent process in a subsequent gateway hot upgrade process to transfer port information and file descriptor information to a new child process. Therefore, in some embodiments, an operation of processing the service request based on the port information and the file descriptor information through the child process includes the following steps.

A target service request of a target process is received. A connection is established between the child process and the target process. The port information and the file descriptor information are transferred to the target process, so as to process the service request based on the port information and the file descriptor information through the target process.

In some embodiments, when the child process is used as the parent process in the subsequent gateway hot upgrade process, the target process is used as a new child process, a service request of the target process is used as a target service request, the target service request of the target process is received, and the connection between the child process and the target process is established. The port information and the file descriptor information are transferred to the target process, so as to process the service request based on the port information and the file descriptor information through the target process, so that the gateway continuously performs a hot upgrade.

The implementation of the method is described below through a specific embodiment.

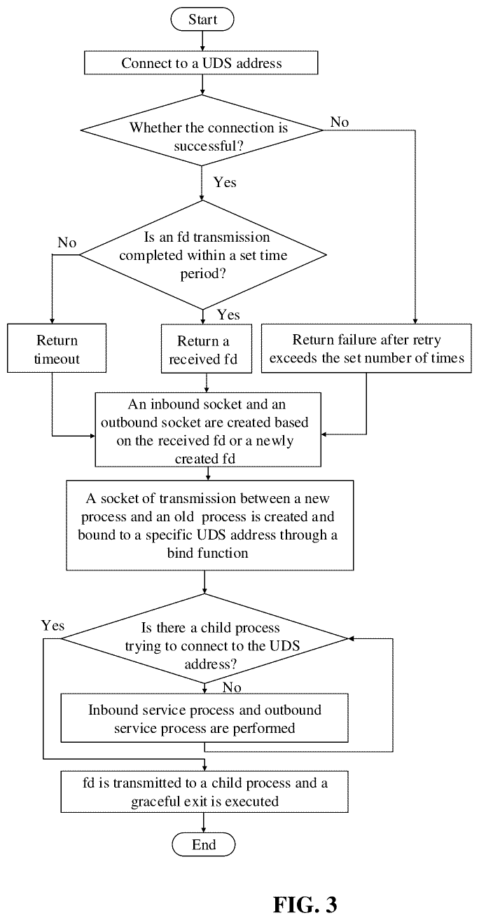

Referring to a schematic diagram of a gateway hot upgrade method shown in FIG. 3, a solution adopted in the present disclosure is to use dual processes to coexist for a time period to ensure transmission of a socket FD between a new process (that is, a child process) and an old process (that is, a parent process), so that a network requests is not interrupted during a hot upgrade. A new process of a gateway attempts to connect to a specific UDS address when a hot upgrade is started. When an old process exists, the new process connects to a socket file previously created by the old process, and an inbound socket FD and an outbound socket FD created by the old process is transferred to the new process. When the old process does not exist, the connection fails, which indicates that a gateway service is deployed for the first time or a Unix domain socket communication error exists, and a retry policy and timeout strategy is needed to ensure that the gateway service can continue to run.

When obtaining the inbound socket FD and the outbound socket FD transferred from the old process, the new process creates new inbound and outbound socket FDs based on the FDs, and finishes binding. In this way, a new network request that passes through the gateway is transferred to the new process for service, and the old process does not terminate immediately at this time, which still needs to wait until the previously established requests have been responded to (or timed out) before terminating. The foregoing new process is connected with a new child process as a parent process during a subsequent hot upgrade, and perform a graceful exit. Then the foregoing process steps are repeated.

In the foregoing steps, the old process first needs to ensure to transfer an FD to the new process when receiving a connection of a new process, and then needs to immediately stop connection of inbound and outbound sockets thereof, to ensure no new connection from the client. This may be implemented by processing exit signal drain and asynchronous connection tasks through a select macro.

In addition, an old process needs to wait until a request that has been previously connected is processed. This implementation is that the gateway service assigns one tokio processing task (similar to a coroutine) to each request, and each task is assigned two asynchronous select macros. The first select macro is configured to process an early exit of the client. The second select macro is configured to process an exit signal drain. When each asynchronous select macro is responded to first, this task performs a corresponding task. The select macro for processing the exit signal drain is sent when the old process needs to perform a graceful exit, and a corresponding processing task is to release the connection after waiting until the request receives a reply or a response times out. In this way, a request that has previously established a connection with the old process needs to wait until the request receives a reply or is returned after a timeout.

Some embodiments of the present disclosure provide a gateway hot upgrade method, which can ensure that the service request that has previously established the connection with an old process needs to wait until the service request receives a reply or is returned after a timeout, and can further ensure that a new request is sent to a new process for processing, so that the service request or response is not interrupted during a gateway upgrade, thereby ensuring high availability and high stability of the gateway.

Some embodiments of the present disclosure further provides a gateway hot upgrade system, including a control module and a processing module. The control module is configured to cut off a connection between a parent process before a hot upgrade of a service request and a child process after the hot upgrade of the service request in response to receiving an exit signal, where the service request is used for establishing the connection between the child process after the hot upgrade and the parent process before the hot upgrade, and the child process is used for receiving port information and file descriptor information transferred by the parent process after the connection is established. The processing module is configured to exit the parent process, and process the service request based on the port information and the file descriptor information through the child process.

In some embodiments of the present disclosure, the connection between the parent process before the hot upgrade of the service request and the child process after the hot upgrade of the service request is cut off when the exit signal is received, and an operation of disconnecting the connection between the parent process and the child process is performed based on the exit signal, to implement control over an exit process of the parent process, thereby reducing a situation where the service request does not receive a reply within a waiting time period and the parent process exits, and further ensuring a graceful exit of the parent process.

In some embodiments, the gateway hot upgrade system further includes a generation module, configured to generate an asynchronous processing task of the service request, where the asynchronous processing task is used for cutting off the connection between the parent process and the child process. The control module is further configured to: perform the asynchronous processing task through an asynchronous processing component.

In some embodiments, the exit signal is sent by a client or a server. The asynchronous processing component includes a first processing component and a second processing component, and The control module is further configured to: cut off the connection between the parent process and the child process through the first processing component in response to a first exit signal sent by the client being first received; and cut off the connection between the parent process and the child process through the second processing component in response to a second exit signal sent by the server being first received.

In some embodiments, the second exit signal is sent after the child process completes processing the connection request or after a response to the connection request times out.

In some embodiments, the processing module is further configured to: identify the parent process based on a first identifier, and identify the child process based on a second identifier, where the parent process is marked through the first identifier in advance in a process management module, and the child process is marked through the second identifier in advance in the process management module; and control the parent process to be in an exit state, and control the child process to be in a running state.

In some embodiments, the processing module is further configured to: receive a return value after the parent process exits, where the return value includes a first return value or a second return value; control the parent process to keep the exit state in response to the return value being the first return value; and start the parent process in response to the return value being the second return value.

In some embodiments, the port information includes outbound port information and inbound port information. The processing module is configured to: generate, through the child process, an outbound port based on the outbound port information, and generate an inbound port based on the inbound port information; generate a Socket file based on the file descriptor information through the child process; and process the service request through the Socket file, the outbound port, and the inbound port.

In some embodiments, the processing module is further configured to: receive a target service request of a target process; establish a connection between the child process and the target process; and transfer the port information and the file descriptor information to the target process, so as to process the service request based on the port information and the file descriptor information through the target process.

Some embodiments of the present disclosure further provide an electronic device, including: at least one processor; and a memory communicatively connected with the at least one processor. The memory stores a computer program that can be executed by the at least one processor, and the computer program, when executed by the at least one processor, is configured to cause the electronic device to perform the gateway hot upgrade method according to the embodiments of the present disclosure.

Some embodiments of the present disclosure further provide a gateway. The gateway performs a gateway hot upgrade according to the foregoing steps of the gateway hot upgrade method.

Some embodiments of the present disclosure further provides a non-transitory computer-readable storage medium storing a computer program, where the computer program, when executed by a processor of a computer, is configured to cause the computer to perform the gateway hot upgrade method according to the embodiments of the present disclosure.

Some embodiments of the present disclosure further provide a computer program product, including a computer program, where the computer program, when executed by a processor of a computer, is configured to cause the computer to perform the gateway hot upgrade method according to the embodiments of the present disclosure.

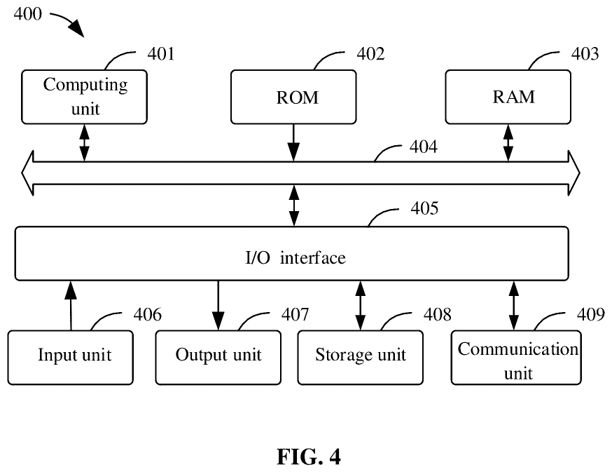

As shown in FIG. 4, a structural block diagram of an electronic device 400 set as a server or a user of the present disclosure is described, which is an example of a hardware device that may be applied to various aspects of the present disclosure. The electronic device is intended to represent various forms of digital electronic computer devices, such as a laptop computer, a desktop computer, a workbench, a personal digital assistant, a server, a blade server, a mainframe computer, and another suitable computer. The electronic device may further represent various forms of mobile apparatuses, such as personal digital processing, a cellular phone, a smart phone, a wearable device, and another similar computing apparatus. The components shown herein, their connections and relationships, and their functions are used as examples, and are not intended to limit implementation of the present disclosure described and/or required herein.

As shown in FIG. 4, the electronic device 400 includes a computing unit 401, which may perform various appropriate actions and processing based on a computer program stored in a read-only memory (ROM) 402 or a computer program loaded into a random access memory (RAM) 403 from a storage unit 408. In the RAM 403, various programs and data required for operations of the device 400 may further be stored. The computing unit 401, the ROM 402, and the RAM 403 are connected with each other through a bus 404. An input/output (I/O) interface 405 is also connected with the bus 404.

Multiple components in the electronic device 400 are connected with the I/O interface 405, including: an input unit 406, an output unit 407, a storage unit 408, and a communication unit 409. The input unit 406 may be any type of device that can input information to the electronic device 400. The input unit 406 may receive input a digit or character information, and generate a key signal input related to a user setting and/or function control of the electronic device. The output unit 407 may be any type of device that can present information, and may include, but is not limited to, a display, a speaker, a video or audio output terminal, a vibrator, and/or a printer. The storage unit 408 may include, but is not limited to, a magnetic disk and an optical disc. The communication unit 409 allows the electronic device 400 to exchange information/data with another device through a computer network such as the Internet and/or various telecommunication networks, and may include, but is not limited to, a modem, a network card, an infrared communication device, a wireless communication transceiver, and/or a chipset, for example, a Bluetooth device, a Wi-Fi device, a WiMax device, a cellular communication device, and/or the like.

The computing unit 401 may be various general-purpose and/or dedicated processing components having processing and computing capabilities. Some examples of the computing unit 401 include, but are not limited to, a processing unit (CPU), a graphics processing unit (GPU), various dedicated artificial intelligence (AI) computing chips, various computing units running machine learning model algorithms, a digital signal processor (DSP), and any appropriate processor, controller, microcontroller, and the like. The computing unit 401 performs the various methods and processes described above. For example, in some embodiments, the foregoing method may be implemented as a computer software program that is tangibly included in a machine-readable medium such as the storage unit 408. In some embodiments, a part or all of the computer program may be loaded into and/or installed on the electronic device 400 through the ROM 402 and/or the communication unit 409. In some embodiments, the computing unit 401 may be configured to perform the foregoing method in any other appropriate manner (for example, through firmware).

Program code for implementing the method of the embodiments of the present disclosure may be written in any combination of one or more programming languages. These program codes may be provided to a processor or a controller of a general-purpose computer, a dedicated computer, or another programmable data processing apparatus, so that the program code, when executed by the processor or the controller, causes functions/operations specified in the flowchart and/or the block diagram to be implemented. The program code may be fully executed on a machine, partially executed on a machine, partially executed on a machine as an independent software package and partially executed on a remote machine, or fully executed on a remote machine or a server.

In the context of the embodiments of the present disclosure, the machine-readable medium may be a tangible medium, which may include or store a program used by an instruction execution system, an apparatus, or a device or used in combination with the instruction execution system, the apparatus, or the device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing content. More specific examples of the machine-readable storage medium include an electrical connection based on one or more wires, a portable computer disk, a hard disk, a random access memory (RAM), a read-only memory (ROM), an erasable programmable ROM (EPROM or a flash memory), an optical fiber, a compact disc ROM (CD-ROM), an optical storage device, a magnetic storage device, or any suitable combination of the foregoing content.

It should be noted that a term “include” and its variants used in the embodiments of the present disclosure are open terms, meaning “including but not limited to”. The term “based on” means “at least partially based on”. The term “one embodiment” means “at least one embodiment”. The term “another embodiment” means “at least one additional embodiment”. The term “some embodiments” means “at least some embodiments”. The modifier “one” or “multiple” mentioned in the embodiments of the present disclosure is illustrative rather than restrictive. A person having ordinary skill in the art should understand that unless otherwise explicitly indicated in the context, the modifier should be understood as “at least one”.

User information (including but not limited to user equipment information, user personal information, and the like) and data (including but not limited to data for analysis, stored data, displayed data, and the like) involved in the embodiments of the present disclosure are all authorized by the user or information and data fully authorized by all parties. The collection, use, and processing of relevant data need to conform to relevant laws, regulations, and standards of relevant countries and regions, and provide corresponding operation portals for the user to choose to authorize or refuse.

Various steps recorded in the method implementations provided in the embodiments of the present disclosure may be performed in different orders and/or performed in parallel. In addition, the method implementations may include additional steps and/or omit performing of shown steps. The protection scope of the present disclosure is not limited in this aspect.

The term “embodiment” in this specification means that specific features, structures, or characteristics described with reference to the embodiments may be included in at least one embodiment of the present disclosure. The phrase appearing at various positions in the specification does not necessarily mean a same embodiment, or does not mean that the phrase is independent or alternative due to being mutually exclusive of other embodiments. Each embodiment in this specification is described in a related manner, and same and similar parts between the various embodiments may be referred to each other. In particular, for the apparatus, device, and system embodiments, since the apparatus, device, and system embodiments are basically similar to the method embodiment, the description is relatively simple. For related parts, reference is made to the partial description of the method embodiment.

The foregoing embodiments describe several implementations of the present disclosure, which are described specifically and in detail, but cannot be construed as a limitation on the patent protection scope. It should be noted that for a person having ordinary skill in the art, several transformations and improvements can be made without departing from the idea of the present disclosure. These transformations and improvements belong to the protection scope of the present disclosure. Therefore, the protection scope of the present disclosure shall be subject to the appended claims.

1. A gateway hot upgrade method, comprising:
cutting off a connection between a parent process before a hot upgrade of a service request and a child process after the hot upgrade of the service request in response to receiving an exit signal, wherein the service request is used for establishing the connection between the child process after the hot upgrade and the parent process before the hot upgrade, and the child process is used for receiving port information and file descriptor information transferred by the parent process after the connection is established; and
exiting the parent process, and processing the service request based on the port information and the file descriptor information through the child process.

2. The gateway hot upgrade method according to claim 1, further comprising:
generating an asynchronous processing task of the service request, wherein the asynchronous processing task is used for cutting off the connection between the parent process and the child process; and
cutting off the connection between the parent process before the hot upgrade of the service request and the child process after the hot upgrade of the service request in response to receiving the exit signal comprises: performing the asynchronous processing task through an asynchronous processing component.

3. The gateway hot upgrade method according to claim 2, wherein the exit signal is sent by a client or a server, the asynchronous processing component comprises a first processing component and a second processing component, and performing the asynchronous processing task through the asynchronous processing component comprises:
cutting off the connection between the parent process and the child process through the first processing component in response to a first exit signal sent by the client being first received; and
cutting off the connection between the parent process and the child process through the second processing component in response to a second exit signal sent by the server being first received.

4. The gateway hot upgrade method according to claim 3, wherein
the second exit signal is sent after the child process completes processing the connection request or after a response to the connection request times out.

5. The gateway hot upgrade method according to claim 1, wherein exiting the parent process comprises:
identifying the parent process based on a first identifier, and identifying the child process based on a second identifier, wherein the parent process is marked through the first identifier in advance in a process management module, and the child process is marked through the second identifier in advance in the process management module; and
controlling the parent process to be in an exit state, and controlling the child process to be in a running state.

6. The gateway hot upgrade method according to claim 5, wherein after exiting the parent process, the method further comprises:
receiving a return value after the parent process exits, wherein the return value comprises a first return value or a second return value;
controlling the parent process to keep the exit state in response to the return value being the first return value; and
starting the parent process in response to the return value being the second return value.

7. The gateway hot upgrade method according to claim 1, wherein the port information comprises outbound port information and inbound port information; and processing the service request based on the port information and the file descriptor information through the child process comprises:
generating, through the child process, an outbound port based on the outbound port information, and generating, through the child process, an inbound port based on the inbound port information;
generating a Socket file based on the file descriptor information through the child process; and
processing the service request through the Socket file, the outbound port, and the inbound port.

8. The gateway hot upgrade method according to claim 1, wherein processing the service request based on the port information and the file descriptor information through the child process comprises:
receiving a target service request of a target process;
establishing a connection between the child process and the target process; and
transferring the port information and the file descriptor information to the target process, so as to process the service request based on the port information and the file descriptor information through the target process.

9. (canceled)

10. (canceled)

11. An electronic device, comprising:
a processor; and
a memory storing a program,
wherein the program comprises instructions, and the instructions, when executed by the processor, causes the processor to perform the following steps:
cutting off a connection between a parent process before a hot upgrade of a service request and a child process after the hot upgrade of the service request in response to receiving an exit signal, wherein the service request is used for establishing the connection between the child process after the hot upgrade and the parent process before the hot upgrade, and the child process is used for receiving port information and file descriptor information transferred by the parent process after the connection is established; and
exiting the parent process, and processing the service request based on the port information and the file descriptor information through the child process.

12. A non-transitory storage medium storing computer instructions, wherein the computer instructions are used for causing a computer to perform the following steps:
cutting off a connection between a parent process before a hot upgrade of a service request and a child process after the hot upgrade of the service request in response to receiving an exit signal, wherein the service request is used for establishing the connection between the child process after the hot upgrade and the parent process before the hot upgrade, and the child process is used for receiving port information and file descriptor information transferred by the parent process after the connection is established; and
exiting the parent process, and processing the service request based on the port information and the file descriptor information through the child process.

13. (canceled)

14. The gateway hot upgrade method according to claim 1, wherein the port information is used for determining a port transferred from the parent process to the child process.

15. The gateway hot upgrade method according to claim 1, wherein the parent process and the child process share the port information and the file descriptor information.

16. The gateway hot upgrade method according to claim 1, wherein the exit signal is used for determining a time point for starting execution of an asynchronous processing task.

17. The gateway hot upgrade method according to claim 7, wherein the outbound port is used for sending a data packet to the external network, the inbound port is used for receiving the data packet from the external network.

18. The gateway hot upgrade method according to claim 2, wherein the port information comprises outbound port information and inbound port information; and processing the service request based on the port information and the file descriptor information through the child process comprises:
generating, through the child process, an outbound port based on the outbound port information, and generating, through the child process, an inbound port based on the inbound port information;
generating a Socket file based on the file descriptor information through the child process; and
processing the service request through the Socket file, the outbound port, and the inbound port.

19. The gateway hot upgrade method according to claim 3, wherein the port information comprises outbound port information and inbound port information; and processing the service request based on the port information and the file descriptor information through the child process comprises:
generating, through the child process, an outbound port based on the outbound port information, and generating, through the child process, an inbound port based on the inbound port information;
generating a Socket file based on the file descriptor information through the child process; and
processing the service request through the Socket file, the outbound port, and the inbound port.

20. The gateway hot upgrade method according to claim 4, wherein the port information comprises outbound port information and inbound port information; and processing the service request based on the port information and the file descriptor information through the child process comprises:
generating, through the child process, an outbound port based on the outbound port information, and generating, through the child process, an inbound port based on the inbound port information;
generating a Socket file based on the file descriptor information through the child process; and
processing the service request through the Socket file, the outbound port, and the inbound port.

21. The gateway hot upgrade method according to claim 5, wherein the port information comprises outbound port information and inbound port information; and processing the service request based on the port information and the file descriptor information through the child process comprises:
generating, through the child process, an outbound port based on the outbound port information, and generating, through the child process, an inbound port based on the inbound port information;
generating a Socket file based on the file descriptor information through the child process; and
processing the service request through the Socket file, the outbound port, and the inbound port.

22. The gateway hot upgrade method according to claim 6, wherein the port information comprises outbound port information and inbound port information; and processing the service request based on the port information and the file descriptor information through the child process comprises:
generating, through the child process, an outbound port based on the outbound port information, and generating, through the child process, an inbound port based on the inbound port information;
generating a Socket file based on the file descriptor information through the child process; and
processing the service request through the Socket file, the outbound port, and the inbound port.
